(19) United States
(12) Patent Application Publication
(10) Pub. No.: US 2025/0037952 A1
(43) Pub. Date: Jan. 30, 2025

(54) HERMETICALLY SEALED SWITCH MODULE

(71) Applicant: Rincon Power, LLC, Capinteria, CA (US)

(72) Inventors: Daniel Charles Sullivan, Santa Barbara, CA (US); Justin McAllister, Ventura, CA (US); Murray McTigue, Carpinteria, CA (US); Marius Avril, Santa Barbara, CA (US)

(73) Assignee: Rincon Power, LLC, Carpinteria, CA (US)

(21) Appl. No.: 18/787,680

(22) Filed: Jul. 29, 2024

Related U.S. Application Data
(60) Provisional application No. 63/529,304, filed on Jul. 27, 2023.

(51) Int. Cl. H01H 50/02; H01H 50/18

(52) U.S. Cl. CPC H01H 50/023; H01H 50/18

(57) ABSTRACT

Switching devices comprising a hermitically sealed switching modules with a core or housing structure that allow for the coil assembly to be mounted outside the hermitically sealed housing. This helps avoid some of the complex manufacturing and testing requirements necessary for conventional coil assemblies arranged inside the sealed housing. The present inventions also provides for improved and more reliable auxiliary switch arrangements, with some embodiments comprising an improved auxiliary arm and auxiliary carrier. The present invention also provides for an improved lunger or shaft structure that allows for operation at high voltage, with some embodiments comprising heat resistance and isolation components particularly arranged to accommodate high voltage operation.

This application claims the benefit of Provisional Patent Application Ser. No. 63/529,304, filed on Jul. 27, 2023.

### BACKGROUND OF THE INVENTION

### Field of the Invention

The present invention relates to hermitically sealed electrical switching devices or contactors.

### Description of the Related Art

Hermetically sealed contactors are magnetically operated devices used for repeatedly establishing and interrupting an electrical power circuit and for switching of high electrical currents and/or high voltages. They typically have fixed and movable internal contacts, and an internal actuating mechanism supported within a hermetically sealed housing. In one type of contactor, air is removed from the contactor housing to create a vacuum that suppresses arc formation, provides long operating life and allows for low resistance operation of the contactor. In another type of contactor, the evacuated chamber can be backfilled under pressure with an insulating gas, which allows the contactor to operate with good arc-suppressing properties.

One type of conventional contactor has moving components housed within a ceramic housing. These types of contactors can operate with a vacuum formed in the housing or with the housing having internal pressure from an injected gas. This allows the contactors to operate with higher voltage and/or lower resistance characteristics and ceramic housings also allow the contactors to operate at high temperature. Ceramic housings, however, can be expensive and difficult to manufacture. Contactors may also comprise a housing with a ceramic header. Ceramic headers offer many of the same voltage, resistance and/or temperature characteristics of ceramic housings as well as offering a means whereby contacts can be electrically isolated from one another. Traditional ceramic headers can be difficult and expensive to manufacture because they are complex shapes that require special tooling, difficult metallization, and time-consuming post processes.

Additionally, conventional contactors have a movable plunger component that is driven by a solenoid in order to move the movable contacts in and out of contact with the stationary contact. These solenoids are often placed inside of the hermetically sealed housing and must be designed and manufactures to withstand the operational environment within the sealed housing. Sealed solenoid driven contactors can be problematic due to pressure build-up on one side of the plunger during plunger travel. This imbalance of pressure slows plunger movement and can reduce solenoid performance. To address this, some relays are provided with a bigger gap in the plunger to reduce the magnetic force or expensive grooves can be machined in the plunger to allow gas to flow by the outside of the plunger as the plunger moves to the stationary contacts.

U.S. Pat. No. 4,039,984 to DeLucia et al. generally discloses a high-voltage magnetic contactor enclosed within a housing of insulating material which contains a gas, such as sulfur hexafluoride. The terminals within the housing extend through its wall and are secured to and sealed to the housing to prevent gas from leaking from the housing. Leads are connected to the terminals externally of the housing, with insulating material surrounding the leads and being secured by the terminals to the housing. An operating mechanism within the housing shifts a pivoted arm electrically connected to one of the terminals within the housing into and from contact with another of the terminals within the housing. The housing is made from a material that has high impact strength and high heat resistance such as a polyamide or polycarbonate resins.

U.S. Pat. No. 4,168,480 to DeLucia discloses a high voltage magnetic contactor that is enclosed by an insulating housing containing a gas, such as sulfur hexafluoride, under pressure. The switch terminals removably extend through a wall of the housing and are sealed. The magnet contactor structure is removably connected to the housing by a sealed joint. A fill valve extends through a wall of the housing and is sealed to the housing. The armature shifts a pivotal arm in the housing between open and closed contact positions. The housing is formed of a polyamide material that is resistant to deterioration by fluorine gas, the material being poly hexamethylene terephthalic amide.

U.S. Pat. No. 5,554,963 to Johler et al. discloses a contactor that includes a plastic enclosure, contacts disposed in the plastic enclosure for selectively operating to make and/or break at least one electrical connection, a gas filling containing at least one electronegative gas, and a sealed plastic encapsulation for preventing the at least one electronegative gas from diffusing away. The electronegative gases are not utilized at high pressure, but under atmospheric pressure or slightly higher pressure. Since normal pressure is used, a hermetically sealed encapsulation can be dispensed with and the enclosure can be made of low-cost plastics without connection to the outside air.

U.S. Pat. No. 6,265,955 to Molyneux et al. generally discloses a contactor having a primary external sidewall formed by a plastic potting cup with a sealed chamber arranged within the cup and having the contactor's moving components. The cup is enclosed at the bottom by a base, with the base and cup serving as a mold to hold epoxy material poured into the cup and cured to provide a hermetic seal. Insulated electrical leads extend through the epoxy material from the sealed chamber for connection of fixed and movable contacts to external circuitry. The base can have a threaded portion that extends from the underside of her cup.

### SUMMARY OF THE INVENTION

The present invention is directed to hermitically sealed switching modules and their various components. In some embodiments, the switching modules can comprise unique housing structures that allow for the coil assembly to be mounted outside the hermitically sealed housing. This helps avoid some of the complex manufacturing and testing requirements necessary for conventional coil assemblies arranged inside the sealed housing. The present inventions also provide for improved and more reliable auxiliary switch arrangements, with some embodiments comprising an improved auxiliary arm and auxiliary carrier. The present invention also provides for an improved plunger shaft structure that allows for operation at high voltage, with some embodiments comprising heat resistance and isolation components particularly arranged to accommodate high voltage operation.

One embodiment of an electrical switching device, according to the present invention comprises a cylindrical hermetically sealed core. Internal components are provided within the core comprise a first fixed contact, a second fixed contact, and a movable contact configured to operate to change the state of the switching device from a closed state allowing current flow through the switching device to an open state which interrupts current flow through the switching device. In some embodiments, the movable contact is operable to move between the open and closed states in response to a magnetic field. A coil or solenoid is included that can be arranged outside of said core and arranged to provide said magnetic field in response to an electrical signal. Magnetically conductive components can be included to provide a magnetic flux path to conduct the magnetic field from the solenoid to the core.

The systems according to the present invention can comprise many different features as described below. These and other aspects and advantages of the invention will become apparent from the following detailed description and the accompanying drawings which illustrate by way of example in the features of the invention.

### BRIEF DESCRIPTION OF THE DRAWINGS

FIG. 1 is a side view of one embodiment of a sealed switch module according to the present invention in its unenergized state;

FIG. 2 is a sectional view of the switch module in FIG. 1;

FIG. 3 is a side view of one embodiment of a switch module according to the present invention energized state;

FIG. 4 is a sectional view of the switch module in FIG. 3;

FIG. 5 is a partial sectional view of the switch module shown in FIGS. 1-4 showing the magnetic flux patent;

FIG. 6 is a front view of the hermetically sealed switch module used in switch modules according to the present invention in its unenergized state;

FIG. 7 is a side view of the module shown in FIG. 6;

FIG. 8 is a side sectional view of the module shown in FIG. 6;

FIG. 9 is a front sectional view of the module shown in FIG. 6;

FIG. 10 is a front view of the hermetically sealed switch module used in switch modules according to the present invention in its unenergized state;

FIG. 11 is a side view of the module shown in FIG. 10;

FIG. 12 is a side sectional view of the module shown in FIG. 10;

FIG. 13 is a front sectional view of the module shown in FIG. 10;

FIG. 14 is a side view of one embodiment of a sealed switch module according to the present invention in its unenergized state;

FIG. 15 is a sectional view of the switch module in FIG. 14;

FIG. 16 is a close-up sectional view of the switch module in FIG. 14 showing the auxiliary arm and micro switch according to the present invention;

FIG. 17 is a side view of one embodiment of a sealed switch module according to the present invention in its energized state;

FIG. 18 is a sectional view of the switch module in FIG. 17;

FIG. 19 is a close-up sectional view of the switch module in FIG. 17 showing the auxiliary arm and micro switch according to the present invention;

FIG. 20 is a perspective view of one embodiment of an auxiliary carrier assembly according to the present invention;

FIG. 21 is a top view of the assembly shown in FIG. 20;

FIG. 22 is a side view of the assembly shown in FIG. 20;

FIG. 23 is an end view of the assembly shown in FIG. 20;

FIG. 24 is a perspective view of one embodiment of an isolated shaft according to the present invention;

FIG. 25 is a side view of the isolated shaft shown in FIG. 24; and

FIG. 26 is a sectional view of the isolated shaft shown in FIG. 24.

### DETAILED DESCRIPTION OF THE INVENTION

The present invention is directed to hermitically sealed switching modules and in particular, improvements in the operation and reliability of such modules.

The present invention is described herein with reference to certain embodiments, but it is understood that the invention can be embodied in many different forms and should not be construed as limited to the embodiments set forth herein. It is further understood that different embodiments can comprise different materials arranged in different ways, and can comprise different features. Different embodiments can also be arranged for mounting to other locations other than directly to a user.

It will be understood that when an element is referred to as being “on” or “connected to” another element, it can be directly on, or in contact with the other element or intervening elements may be present. In contrast, when an element is referred to as being “directly on”, or “directly connected to” another element, there are no intervening elements present. Although the terms first, second, etc. may be used herein to describe various elements, and/or sections, these elements and/or sections should not be limited by these terms. These terms are only used to distinguish one element, or section from another element, or section. Thus, a first element or section discussed herein could be termed a second element, or section without departing from the teachings of the present invention.

Embodiments of the invention are described herein with reference to perspective view illustrations that are schematic illustrations of an embodiment of the invention. As such, the actual thickness or size of components can be different, and variations from the shapes of the illustrations as a result, for example, of manufacturing techniques and/or tolerances are expected. Embodiments of the invention should not be construed as limited to the particular shapes as illustrated herein but are to include deviations in shapes that result, for example, from manufacturing. A region or element illustrated or described as being generally square or rectangular can have rounded or curved features due to normal manufacturing tolerances. Thus, the features illustrated in the figures are schematic in nature and their shapes are not intended to illustrate the precise shape of a feature of a device and are not intended to limit the scope of the invention.

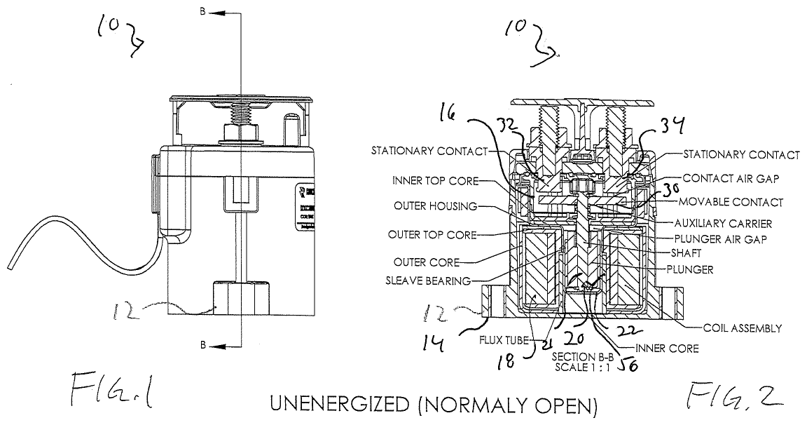

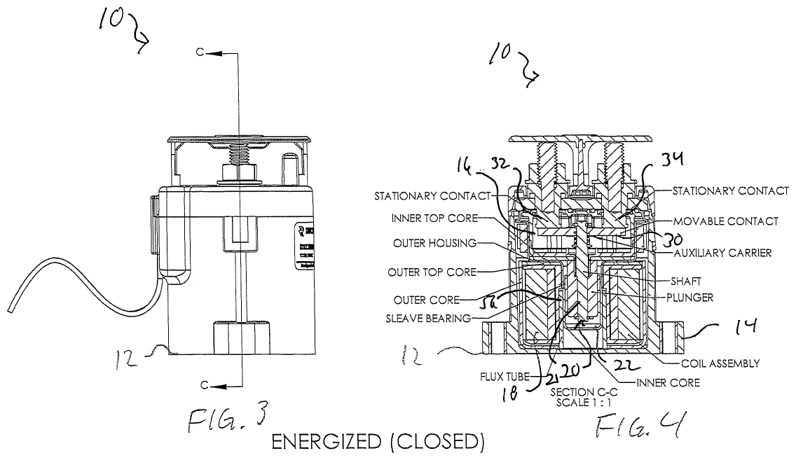

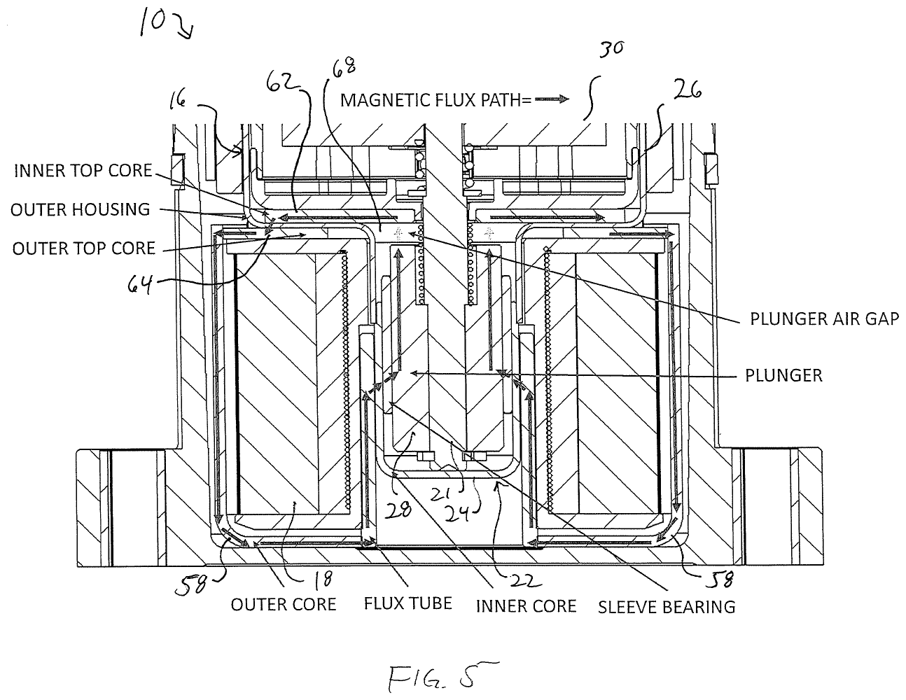

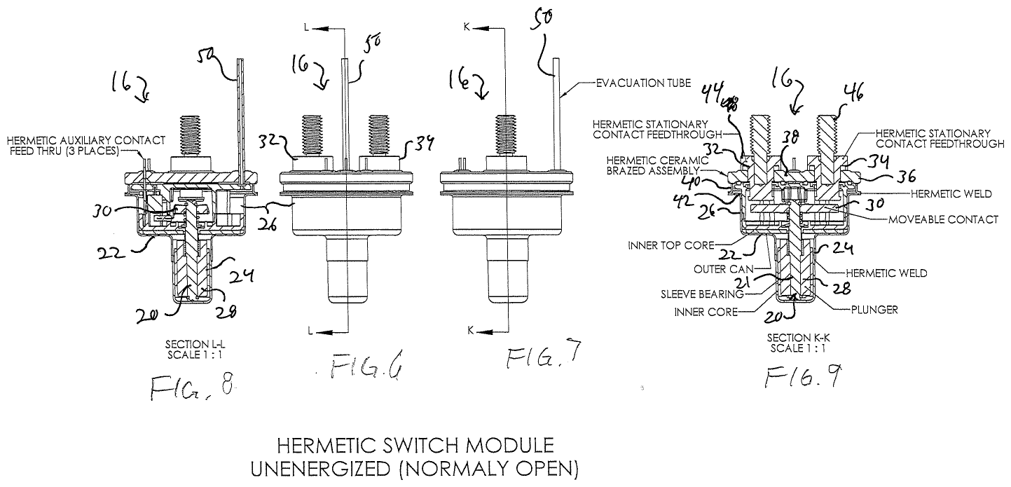

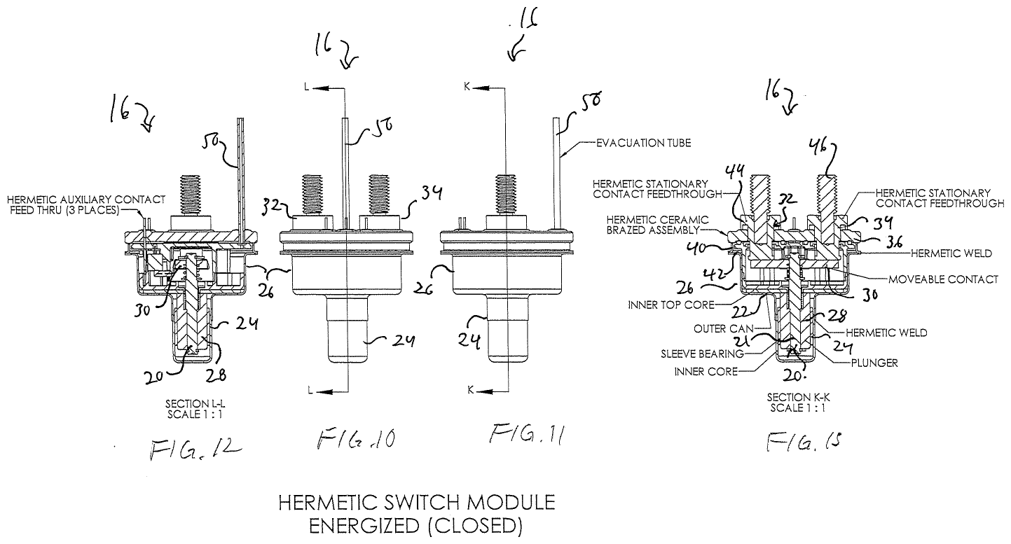

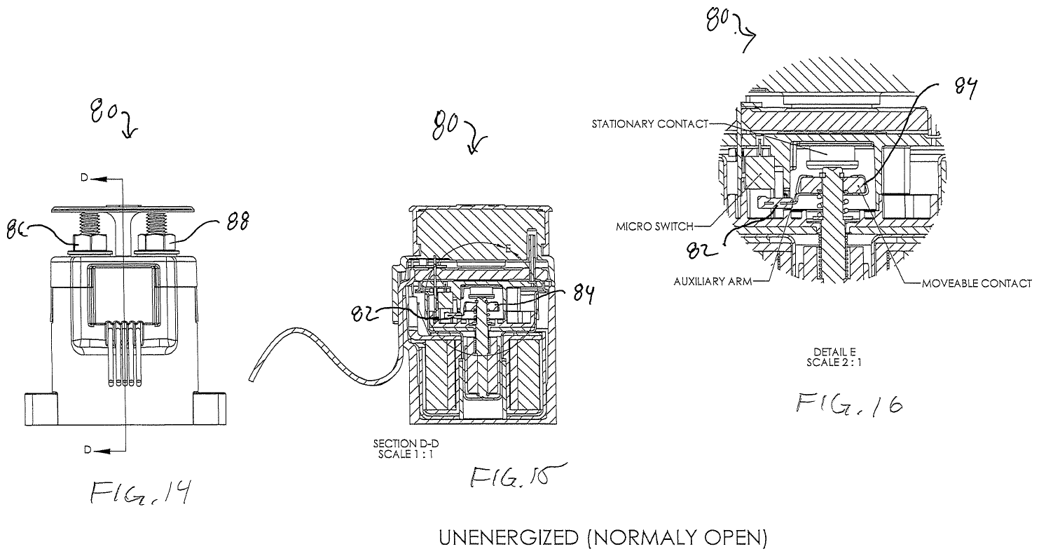

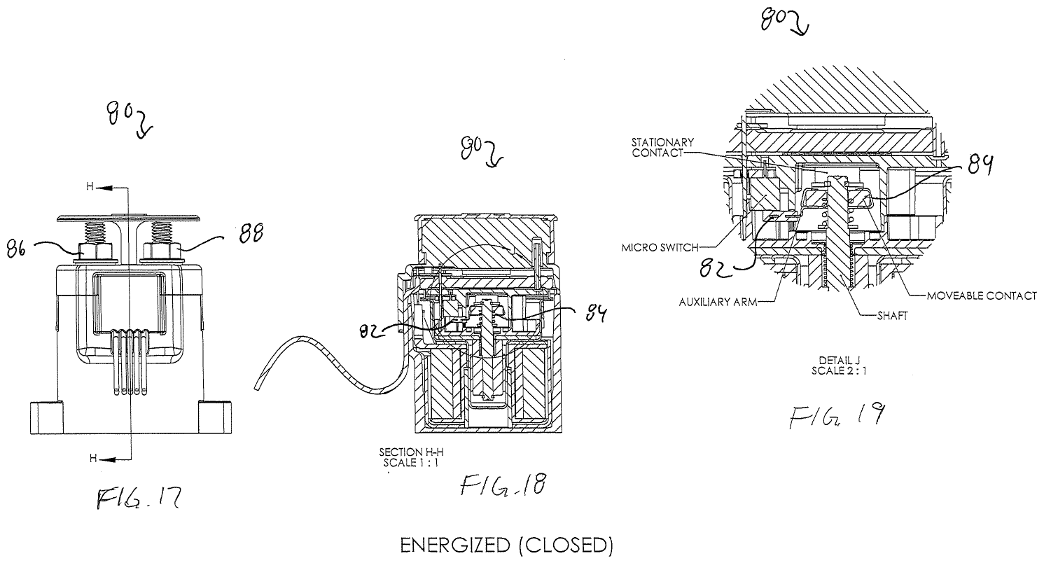

FIGS. 1 through 5 show one embodiment of hermetically sealed switching device (i.e. contactor) according to the present invention, with FIG. 6 through 13 showing one embodiment of a hermetically sealed switch module that can be used in the switching modules according to the present invention. The following discusses the features of the embodiment shown in FIGS. 1 through 13.

The switching module or contactor 10 according to the present invention comprises an cylindrical outer cap 12 for holding the module 10 in the desired orientation and also comprises mounting points 14 for mounting the contactor in place for use using known mounting methods such as bolts or screws. The cap 12 being made of many different materials such as a low permeability plastic or polymer.

In the embodiment shown, the contactor 10 further comprises a hermetically sealed cylindrical switch module 16 holding most of the contactor's moving components. An external coil assembly 18 is included that is operable to generate a magnetic field to cause motion of the plunger 20 within the hermetically sealed switch module 16.

The hermetically sealed switching module 16 comprises an cylindrical inner housing or core 22 for holding the moving components of the contactor 10, with the inner core shown comprising a lower cylindrical smaller diameter portion 24 below an upper cylindrical larger diameter portion 26. The lower portion 24 contains the lower portion of the plunger 20, the plunger shaft 21, and the plunger magnetic portion 28 that reacts to and is operable by the magnetic field produced by the coil assembly to cause movement of the plunger 20. The core upper portion 26 contains the upper portion of the plunger shaft 21, the movable contact 30, and first and second fixed contacts 32, 34.

The core 22 can comprise any suitable material that can support the structure and function of the contactor device 10 as disclosed herein, with a preferred material being a sturdy material that can provide structural support to the contactor device 100 without interfering with the electrical flow through the fixed contacts 32, 34 and the internal components of the device. In some embodiments, the core 22 comprises a durable plastic or polymer, or a metal or combination of metals. In some embodiments, the core 22 can at least partially comprise a material that conducts a magnetic field or flux. In still other embodiments it can at least partially comprise stainless steel that does not efficiently conduct a magnetic field or flux. The core 22 at least partially surrounds the various internal components of the contactor device 10 which are described in more detail further herein, while in other embodiments the core 22 fully surrounds the internal components.

The core 22 can comprise any shape suitable for housing the various internal components including any cylindrical, regular or irregular polygon, with the embodiment shown being cylindrical. The core 22 can be a continuous structure, or can comprise multiple component parts joined together. In the embodiment shown, the core 22 comprises a lower core 24 and an upper core 26, with the lower core 24 being hermetically welded to the upper core 26.

The fixed contacts 32, 34 are configured such that the various internal components of the contactor device 10 that are housed within the core 22 can electrically communicate with an external electrical system or device, such that the contactor device 10 can function as a switch to break or complete an electrical circuit as described herein. The fixed contacts 32, 34 are shown as hermetic stationary contact feedthroughs mounted to a passing through a hermetic ceramic brazed assembly 36. The assembly 36 comprises a ceramic header 38 and a first brazing flange 40 around the edge of the ceramic header 38 that rests on top of a second brazing flange 42 around the edge of the upper core 26. A hermetic weld is included at the first and second flanges 40, 42 and there is a hermetic seal between the fixed contact 32, 34 and the header 38 such that the module 16 is hermetically sealed.

The fixed contacts 32, 34 can comprise any suitable conductive material for providing electrical contact to the internal components of the contactor device, for example, various metals and metallic materials or any electrical contact material or structure that is known in the art. The fixed contacts 32, 34 can comprise single continuous contact structures or can comprise multiple electrically connected structures (as shown). For example, in some embodiment shown, the fixed contacts 32, 34 each comprise a hermetic stationary contact feedthrough assembly 44 and a contact post 46 for connecting to the contactor 10. The movable contact 30 is mounted to the end of the plunger 20 such that movement of the plunger causes movement of the movable contact 30 in and out of contact with the fixed contacts 32, 34, as described in more detail below.

The module 16 can further comprise an evacuation tube 50 configured such that the internal space of the core 22, which houses the various internal components of the contactor 10, is hermetically sealed. The evacuation tube 50 can allow for the creation of a vacuum within the core 20 and can also allow for the introduction of a gas. This hermetically sealed configuration with a vacuum and gas can help mitigate or prevent electrical arcing between adjacent conductive elements, and in some embodiments, helps provide electrical isolation between spatially separated contacts. In some embodiments, the core 22 can be at least partially filled with an electronegative gas, for example, sulfur hexafluoride or mixture of nitrogen and sulfur hexafluoride and the core 22 comprises a material having low or substantially no permeability to the gas. In other embodiments, the core can comprise various gasses, liquids or solids configured to increase performance of the device.

During operation, the contactor 10 can be operable between open condition when the movable contact 30 is not in contact with the stationary contact 32, 34, and a closed condition when the movable contact is in contact with the stationary contacts 32, 34. When in the open condition as shown in FIGS. 2, 8 and 9, the fixed contacts 32, 34 are not interacting with any of the other components internal to the core 10 and the fixed contacts 32, 34 are otherwise electrically isolated from one another such that electricity cannot freely flow between the two.

When the contactor 10 is in the closed condition as shown in FIGS. 4, 12 and 13, both of the otherwise electrically isolated fixed contacts 32, 34 are contacted by moveable contact 30. The moveable contact 30 functions as a conductive bridge allowing an electrical signal to flow through the device, for example, from the first fixed contact 32, to the moveable contact 30, and to the second contact 34 or vice versa. Therefore, the contactor 10 can be connected to an electrical circuit, system or device and can complete a circuit while the moveable contact 30 is in electrical contact with the fixed contacts 32, 34.

The moveable contact 30 can comprise any suitable conductive material including any of the materials discussed herein in regard to the fixed contacts 32, 34. Like with the fixed contacts 32, 34, the moveable contact 30 can comprise a single continuous structure (as shown), or can comprise multiple component parts electrically connected to one another so as to serve as a contact bridge between the otherwise electrically isolated fixed contacts 32, 34, so that electricity can flow through the contactor 10.

The moveable contact 30 can be configured such that it can move into and out of electrical contact with the fixed contacts 32, 34. This causes the circuit to be “closed” or completed when the moveable contact is in electrical contact with the fixed contacts 32, 34, and to be “open” or broken when the moveable contact 30 is not in electrical contact with the fixed contacts 32, 34. The fixed contacts 32, 34 are otherwise electrically isolated from one another when not contacting the moveable contact 30. In the embodiments shown, the moveable contact 30 is connected to plunger shaft 21 and its end near the fixed contact 32, 34. The plunger shaft 21 is configured to move along a predetermined distance within the core. The plunger shaft 21 and plunger magnetic portion 28 can comprise any material or shape suitable for its the plunger's function as an internal moveable component that is physically connected to the moveable contact 30, such that the moveable contact 30 can move with the plunger 20.

Movement of the plunger 20 controls movement of the moveable contact 30, which in turn controls the position of the moveable contact 30 in relation to the fixed contacts 32, 34. This in turn controls flow of electricity through the contactor 10 as described herein. Movement of the plunger 20 can be controlled through various configurations, including, but not limited to, electrical and electronic, magnetic and solenoid, and manual.

In the embodiment of the contactor 10 shown, movement of the plunger 20 is controlled through the use of a coil or solenoid configuration. As mentioned above, the plunger's magnetic portion 28 is at the base of the plunger 20 and in the lower core 24. The magnetic portion 28 is connected to, and at least partially surrounds, a portion of the base of the plunger shaft 21. The magnetic portion 28 is made of a material that is movable under a magnetic field such as that produced by a conductive coil or solenoid. Causing movement of the magnetic portion 28 under a magnetic field causes corresponding movement of the plunger 20 and thereby movement of the moveable contact 30.

As discussed above, conventional contactors have solenoids within the hermetically sealed core or body. This provided challenges in making electrical contact to the solenoid without impacting the core's hermetic seal. The internal solenoid also had to be designed and tested to withstand the environment within the hermetically sealed housing, which can comprise a vacuum and one or more electronegative gasses. Repair and replacement of internal solenoids is also complicated and, in some instances, not possible.

In the embodiments according to the present invention, the coil assembly or solenoid 18 is provided external to the core 22, and the contactor 10 is arranged such that the magnetic field generated by the solenoid can still act on and cause movement of the plunger magnetic portion 28, the plunger shaft 21, and the movable contact 30. Referring now to FIGS. 2, 4 and 5, a coil assembly or solenoid 18 is provided that is generally cylindrical or disk shaped and sized to fit within the cap 12. The solenoid 18 has a central opening 56 sized to fit and hold the lower core 24. This results in the plunger structure 28 and the lower portion of the plunger 20 to also be within the opening 56. An electrical signal applied to the solenoid 18 generates a magnetic field that penetrates the core 22 and operates on the magnetic portion 28 to cause movement of the magnetic portion 28. Many different solenoids can be used in the different embodiments according to the present invention such as commercially available or custom-made solenoids.

By having the solenoid 18 external to the core 22, the solenoid 18 need not be designed and tested to withstand the environment within the core 22, and conductors do not need to be included through the core to operate the solenoid 18. The contactors according to the present t invention should be arranged such that the magnetic field of the solenoid still passes into the core 22 to operate on the plunger structure 28. By having cylindrical core 22, with cylindrical lower portion 24 and upper portion 26, the contactor 10 provides additional advantages. The cylindrical shape of the upper portion 26 provides for increases space with the arc chamber compared to square or rectangular contactor. This allows the contactors according to the present invention to more conveniently include additional within the arc chamber such as auxiliary switches and arc magnets. The cylindrical shape of the upper portion also allows for a disk shaped ceramic header 38, which can require less ceramic material, and can be easier and less costly to manufacture. The cylindrical shape of the inner core 22 also allows for manufacturing of the contactor 10 with a reduced number of welds as discussed below.

Referring now to FIG. 5, the inner core 22 is shown arranged within the opening of a cylindrical external coil 18, all of which are within and outer core 58. These and other components are designed to provide a magnetic circuit that can conduct magnetic flux from the external coil 18 to the plunger 20 to actuate the plunger 20 between open and closed positions as described above. The components surrounding the solenoid can be made of materials that conduct a magnetic field, such as different metals or combination of metals. In some embodiments, the parts can comprise low carbon steel while other components such as the outer upper core portion 26 (outer can), can comprise stainless steel. An inner top core 62 can be included at the bottom of the upper portion 26, and can comprise a material that conducts an magnetic flux, such as a low carbon steel. An outer top core 64 can be included on the top surface of the coil 18, running parallel to the inner top core 62, with a portion of the outer upper core portion 26 between the two. A flux tube 60 can be included at the base of the coil outer core 58, with the flux tube 60 and coil outer core 58 also made of a material that can conduct magnetic flux, such as low carbon steel.

This arrangement provides a magnetic circuit structural layout with the desired magnetic flux path as shown in FIG. 5. The magnetic circuit provides a path for passing the magnetic flux from the solenoid 18 through the coil outer core 58, through the flux tube 60 and into the plunger magnetic portion 28. The magnetic flux crosses the plunger air gap 68 and passes from the magnetic portion 28 to inner top core 62, into the outer top core 64 and back to the coil outer core 58. This provides and efficient path for the magnetic flux to operate on the plunger structure 28, while still allowing for the solenoid 18 to be external to the hermetically sealed core 22. The outer housing 58 can be made of stainless steel that does not efficiently conduct magnetic flux. This encourages the magnetic flux to cross the plunger air gap 68 without being shunted through the outer housing 26, thereby providing the efficient magnetic path as shown to operate on the plunger 29.

This arrangement provides a number of advantages including allowing for a contactor assembly with reduced number of welds required for assembly compared to conventional devices. For example, the flux tube 60 can be press fit into the coil outer core 58, and the external coil 18 can be placed in the coil outer core 58 and the outer top core 64 on top of the external coil 18 in the coil outer core 58. The core 22 can then be placed on the coil outer core 58 with the lower portion 24 arranged in the central opening of the coil as shown, with all of the above being assembled without welds. This arrangement also allows for components for some components to be more accessible for repair and replacement, such as the external solenoid 18. All of the above allows for efficient and reliable operation of the contactor 10 while also using a solenoid 18 external to the core 22.

It is understood that the present invention can have many more unique features beyond those described above. For example, the present invention also provides: for an improved internal switching arrangement with improved auxiliary contact arm structure and auxiliary carrier assemble. FIGS. 14 through 19 show one embodiment of a contactor 80 according to the present invention with an improved auxiliary arm/carrier assembly 82 mounted on the movable contact 84. As the movable contact 84 moves in and out of contact with the stationary contacts 86, 88, the carrier assembly 82 activates a microswitch 90 which can be monitored to report the open or closed state of the contactor 80 (i.e. open or closed).

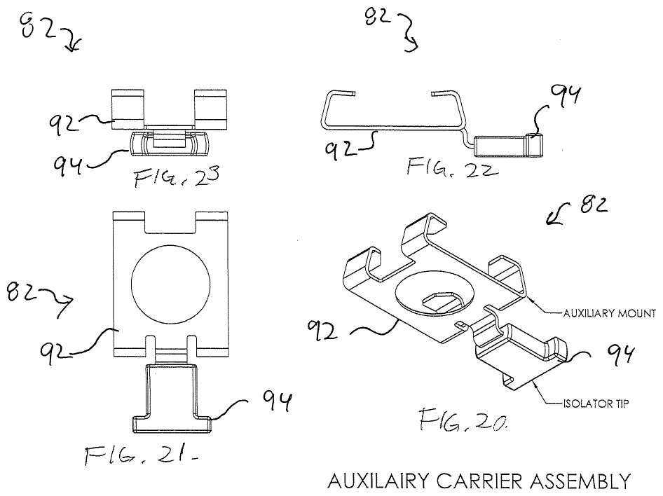

FIGS. 20 through 23 show one embodiment of an auxiliary carrier assembly 82 according to the present invention. The auxiliary carrier assembly 82 comprise a composite structure that can be made of many different materials but is preferably make of material that provides heat resistance and isolation. In the embodiment shown, the carrier assembly comprises an auxiliary mount 92 and an isolator tip 94. The auxiliary mount 92 comprises the portion of the assembly 82 that mount to and contacts the moveable contact 84. It can comprise many different materials such as a stainless spring steel material that that can withstand high temperatures. This provides for a much more robust and reliable assembly compared to conventional assemblies that can be made of materials such as plastic that can fail in high current and high temperature applications. The isolator tip 94 can be made of many different materials including many different plastics. In some embodiments, the tip 94 can be made of a is a non-conductive engineering plastic such as commercially available plastics Zytel FR50 name. It is understood that other material with similar properties can also be used.

The auxiliary mount 92 can be sized and shaped so that it can be press fit onto moveable contact 84 and utilizes the shape of the moveable contact 84 and the plunger to retain and hold the assembly 82 on the movable contact 84. Using the arrangement, no welding or other retention mechanism (e.g. screws or brackets) are required, thereby making manufacturing easier and less costly.

During movement of the movable contact 84, the auxiliary isolator tip 94 can actuate an integrated microswitch 90 as described above. In some embodiments, the microswitch 90 can comprise a switch plunger that is actuated by the isolator tip 94. This arrangement allows for the microswitch to give direct feedback of the moveable contact's state/position and thereby the state of the contactor 80. This arrangement provides an improvement over conventional auxiliary contacts that are actuated off the movable plunger, such as at the plunger shaft, which can give false indication of true moveable contact position. The auxiliary isolator tip 94 provides the additional advantage of acting as an alignment feature for the movable contact 84. The actuator tip rides up and down with the movable contact in a slot in the contactor's arc envelope. This helps to keep the movable contact 84 aligned in the core and the helps prevent the moveable contact 84 from rubbing on the walls of the arc envelope.

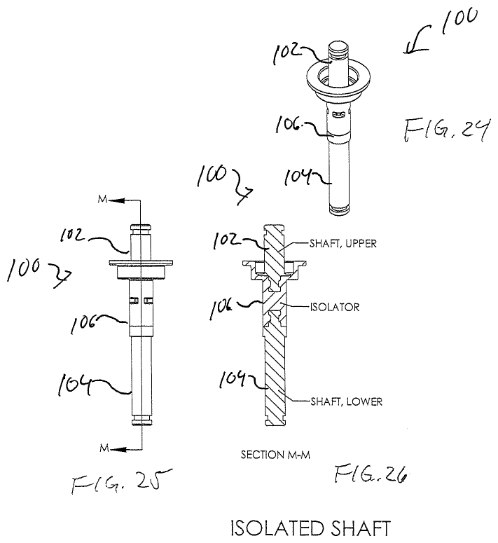

The present invention provides other improvements and advantages, and provides different embodiments of an improved isolated plunger shaft that can be used with the movable contact as described above, and can provide electrical isolation for the movable contact. FIGS. 24 through 26 show one such embodiment of an isolated shaft 100 according to the present invention that is particularly applicable to higher voltage operation. The isolated shaft 100 is composite structure for heat resistance and isolation. The shaft 100 comprises an upper shaft portion 102 and a lower shaft portion 104, each of which can be made of the same or different materials. In the embodiment shown, the upper and lower shaft portions 102, 104 comprise a metal but preferably stainless steel. The shaft 100 further comprises and isolator portion 106 that can comprise many different materials and can be formed using many different methods. In the embodiment shown, the isolator portion 106 is over molded between and connects to the upper and lower portions 102, 104. The isolator portion 106 comprises a non-conductive material such as a non-conductive engineering plastic, such as commercially available plastics sols as Zytel FR50. It is understood that many different plastics can be used that have similar properties.

One of the advantages of isolated shaft 100 is that during operation of a contactor using the shaft as or part of the plunger, the isolator portion can serve to electrically isolate the moveable contact from the rest of the structure. This can be particularly important when the under high voltage operation when the when the movable contact is in the closed position and may be carrying an elevated electrical signal. The isolation of the movable contact as provided herein can also improve the dielectric withstand performance between closed contacts and coil/solenoid, and closed contacts and auxiliary contacts. This structure also improves the manufacturability with regards to isolating at higher voltages as it reduces the need for the application of additional materials such Kapton tape and isolating sealants. Another benefit is that the insulation resistance performance during hot switch cycling can be improved as there will be fewer breakdown paths, leaving insulation resistance between main contacts as the only concern. In conventional non-isolated shaft design, there can be internal leakage paths that form during hot switch cycling between the stationary contacts and the coil and auxiliary connections due plate out.

The shaft 100 also other improvements such as the upper portion 102 having an integrated shoulder for the contact spring to rest. The plastic isolator portion 106 can also have a coaxial wall that surrounds the contact spring. These features serve to improve creepage distance between the upper shaft and lower shaft portions 102, 104. The isolator portion 106 can also serve as mid-section bearing surface for actuation.

It is understood that many different mechanisms and arrangements can be used in the different systems according to the present invention. Although the present invention has been described in detail with reference to certain configurations thereof, other versions are possible. Therefore, the spirit and scope of the invention should not be limited to the versions described above.

We claim:

1. An electrical switching device, comprising:
a cylindrical core;
internal components within said core comprising a first fixed contact, a second fixed contact, and a movable contact mounted on a plunger configured to operate to change the state of said switching device from a closed state allowing current flow through said switching device to an open state which interrupts current flow through said switching device;
wherein said plunger is operable to move between said open state and said closed state in response to a magnetic field;
a solenoid arranged outside of said core arranged to provide said magnetic field in response to an electrical signal;
magnetically conductive components providing a magnetic flux path to conduct said magnetic field from said solenoid to said plunger.

2. The device of claim 1, wherein said solenoid surrounds at least a portion of said core.

3. The device of claim 1, wherein said core is hermetically sealed.

4. The device of claim 1, wherein said core comprises portions of different sizes.

5. The device of claim 4, wherein said core is cylindrical and said portions comprise at least two portions with differing diameters.

6. The device of claim 1, further wherein said plunger comprises a plunger shaft, wherein said moveable contact is mounted near one end of said plunger shaft, and the other end of said plunger reacting to said magnetic field to move said movable contact.

7. The device of claim 1, further comprising an auxiliary carrier assembly on said movable contact.

8. The device of claim 7, wherein said auxiliary carrier assembly comprises an auxiliary mount and an isolator tip.

9. The device of claim 1, further comprising an composite plunger shaft to provide an electrically isolated movable contact.

10. An electrical switching device, comprising:
a hermitically sealed cylindrical core comprising a first core portion with a first diameter, and second core portion with a second diameter smaller than said first diameter;
internal components within said core comprising a first fixed contact, a second fixed contact, a movable plunger and a movable contact mounted to said movable plunger, said movable plunger and contact movable between a first and a second in response to a magnetic field;
a coil arranged outside of said core and around said second core portion, wherein said coil applies said moving magnetic field to said movable plunger in response to an electrical signal, wherein said magnetic field passes from said coil to said movable plunger through a magnetic path comprising magnetically conductive components.

11. The device of claim 10, wherein said coil comprises a solenoid.

12. The device of claim 10, further comprising a plunger shaft structure, wherein said moveable contact is mounted near one end of said shaft, and plunger magnetic portion is mounted near the other end of said plunger shaft, said plunger magnetic portion reacting to said magnetic field to move said movable contact.

13. The device of claim 10, further comprising an auxiliary carrier assembly on said movable contact.

14. The device of claim 13, wherein said auxiliary carrier assembly comprises an auxiliary mount and an isolator tip.

15. The device of claim 14, wherein said auxiliary mount is press fit on said movable contact.

16. The device of claim 10, wherein said plunger comprising an isolator portion.

17. The device of claim 10, wherein said plunger further comprises an composite plunger shaft to provide an electrical isolation to said movable contact.

18. An electrical switching device, comprising:
a sealed core;
internal components within said core comprising a first fixed contact, a second fixed contact, a movable plunger and a movable contact mounted on said movable plunger, said device configured to operate to change the state of said switching device from a closed state allowing current flow through said switching device to an open state which interrupts current flow through said switching device;
wherein said movable plunger electrically isolated and is operable to move between said open state and said closed state in response to a magnetic field; and
wherein said plunger comprises a non-conductive isolator portion.

19. The device of claim 18, further comprising a solenoid arranged outside of said core and arranged to generate said magnetic field in response to an electrical signal.

10. The device of claim 18, wherein said plunger comprises a composite plunger shaft composite e plunger shaft comprising a conductive upper portion and lower portion, and wherein said isolator portion is between said upper and lower portion to provide said electrical isolation for said movable contact.
